(19) United States
(12) Patent Application Publication
(10) Pub. No.: US 2010/0216008 A1
(43) Pub. Date: Aug. 26, 2010

(54) SECONDARY BATTERY MODULE

(76) Inventor: Jihyoung Yoon, Suwon-si (KR)

Correspondence Address: CHRISTIE, PARKER & HALE, LLP, PO BOX 7068, PASADENA, CA, 91109-7068, US

(21) Appl. No.: 12/713,016

(22) Filed: Feb. 25, 2010

(30) Foreign Application Priority Data
Feb. 26, 2009 (KR) 10-2009-0016323

(51) Int. Cl. H01M 2/24

(52) U.S. Cl. 429/158

(57) ABSTRACT

A secondary battery module having a major axis of a connection terminal crossing a connection axis of a fastening member to increase coupling force and decrease contact resistance. An embodiment of a secondary battery module includes: a plurality of unit batteries including electrode terminals; a plurality of connection terminals, each coupled to and electrically connected to a respective one of the electrode terminals of the unit batteries, each of the connection terminals having a major axis extending along a length of the connection terminal; a bus bar electrically connecting connection terminals of the plurality of connection terminals; and a plurality of fastening members fastening the connection terminals to the bus bar, each of the fastening members extending in a direction crossing the major axis of one of the connection terminals, wherein the bus bar includes at least one contact surface parallel to a contact surface of each of the connection terminals.

### CROSS-REFERENCE TO RELATED APPLICATION

This application claims priority to and the benefit of Korean Patent Application No. 10-2009-0016323, filed on Feb. 26, 2009, the entire content of which is incorporated herein by reference.

### BACKGROUND OF THE INVENTION

1. Field of the Invention

The present invention relates to a secondary battery module.

2. Description of the Related Art

Generally, a secondary battery is a battery that can be repeatedly charged and discharged, unlike a primary battery incapable of being recharged. A low capacity secondary battery pack including a single cell has been used in small portable electronic apparatuses, such as mobile phones, notebook computers, and camcorders. A large capacity secondary battery including several tens of cells connected to each other has been widely used as a power source for driving a motor of a hybrid electric vehicle or the like.

A secondary battery is manufactured in various shapes, for example a cylindrical or box shape. A serial connection of a plurality of rechargeable batteries produces a large capacity secondary battery module.

A typical secondary battery module includes a plurality of serially connected unit batteries. Each unit battery includes an electrode assembly including a positive electrode, a negative electrode, and a separator interposed therebetween; a case having a receiving space for holding the electrode assembly; a cap assembly combined with the case to seal the case; and positive and negative terminals protruding outward from the cap assembly and being electrically connected to current collectors of positive and negative electrode plates of the electrode assembly.

Unit batteries are serially connected to each other in such a way that a positive terminal of each unit battery is connected to a negative terminal of each adjacent unit battery via a nut and a conductive connection member to thereby complete a large capacity secondary battery module.

That is, negative and positive terminals are formed in a male screw configuration, and thus, unit batteries are serially connected to each other in such a way that a conductive bus bar is mounted on a positive terminal of each unit battery and a negative terminal of each adjacent unit battery, and nuts are then screwed onto the terminals to secure the bus bar to the terminals.

In such a conventional secondary battery module, however, a contact area between an electrode terminal and a bus bar is small, thus increasing contact resistance, leading to lowered current collection efficiency.

Moreover, in order to reduce contact resistance between an electrode terminal and a bus bar, it is required to apply a sufficiently high pressure to nuts. However, since a nut is rotated about the same axis as the major axis of an electrode terminal, such a high pressure may cause a coupling defect between the nut and the electrode terminal, due to the electrode terminal being rotatably moved. Thus, when a nut is coupled to an electrode terminal, an insufficient pressure is used, thereby undesirably increasing a contact resistance. As such, a problematic aspect of a secondary battery module is a difficulty in determining an appropriate pressure necessary for coupling a nut and an electrode terminal considering contact resistance.

### SUMMARY OF THE INVENTION

Embodiments of the present invention provide a secondary battery module in which the major axis of a connection terminal crosses the connection axis between the connection terminal and a fastening member. Therefore, it is possible to couple the connection terminal to a bus bar by applying a sufficiently high pressure to the fastening member while maintaining a coupled state between an electrode terminal of a unit battery and the connection terminal, thus ensuring decreased contact resistance between the connection terminal and the bus bar.

Embodiments of the present invention also provide a secondary battery module in which positive terminals of unit batteries have a different height from negative terminals of the unit batteries, thus enabling easy distinction between the positive and negative terminals of the unit batteries when arranging and serially connecting the unit batteries to manufacture the secondary battery module.

Embodiments of the present invention also provide a secondary battery module capable of controlling the spatial orientation of contact surfaces of connection terminals so that the contact surfaces are contacted in parallel to a contact surface of a bus bar when the connection terminals are coupled to electrode terminals of unit batteries, thus ensuring increased current collection efficiency and decreased contact resistance between the contact surfaces of the connection terminals and the bus bar.

According to an embodiment of the present invention, a secondary battery module includes: a plurality of unit batteries including electrode terminals; a plurality of connection terminals, each coupled to and electrically connected to a respective one of the electrode terminals of the unit batteries, each of the connection terminals having a major axis extending along a length of the connection terminal; a bus bar electrically connecting connection terminals of the plurality of connection terminals; and a plurality of fastening members fastening the connection terminals to the bus bar, each of the fastening members extending in a direction crossing the major axis of one of the connection terminals, wherein the bus bar includes at least one contact surface parallel to a contact surface of each of the connection terminals.

The connection terminals may include: contact portions coupled to the bus bar; and coupling portions integral with the contact portions and coupled to the electrode terminals of the unit batteries.

The contact portions of the connection terminals may include the contact surfaces of the connection terminals, and the contact surfaces may be substantially flat and contacting the bus bar.

The at least one contact surface of the bus bar may be substantially flat and closely contacting the contact surfaces of the connection terminals.

The contact surfaces of the connection terminals may have at least one shape selected from the group consisting of a circular shape, a polygonal shape with a plurality of straight sides, a polygonal shape with a plurality of convexly curved sides, and a polygonal shape with a combination of a plurality of straight sides and convexly curved sides.

The coupling portions of the connection terminals may be welded to the electrode terminals of the unit batteries.

The electrode terminals of the unit batteries may have a threaded bolt shape.

The coupling portions of the connection terminals may have internal threaded apertures, and the electrode terminals may be threadedly inserted into the threaded apertures of the coupling portions, and the connection terminals may have a height relative to the electrode terminals, and the contact portions of the connection terminals may include the contact surfaces of the connection terminals. The height of each of the connection terminals may be adjustable via threaded rotation of the connection terminal relative to a corresponding one of the electrode terminals.

The contact portions of the connection terminals may have terminal through-holes extending therethrough and receiving the fastening members coupling the connection terminals and the bus bar.

The bus bar may have bus bar through-holes extending therethrough and corresponding to the terminal through-holes of the connection terminals for coupling the connection terminals and the bus bar.

The bus bar may have two bus bar through-holes spaced from each other by a same distance as a distance between electrode terminals of two adjacent ones of the unit batteries.

Each of the fastening members may include: a bolt extending through the terminal through-holes at the contact portions of one of the connection terminals and one of the bus bar through-holes; and a nut coupled to the bolt for fastening the one of the connection terminals to the bus bar.

The electrode terminals of the unit batteries may include positive terminals and negative terminals.

The positive terminals of the unit batteries may have a different height than the negative terminals of the unit batteries.

The bus bar may electrically connect a positive terminal of one of the unit batteries and a negative terminal of an adjacent one of the unit batteries to serially connect the one unit battery and the adjacent unit battery.

The unit batteries may have a box shape.

Each of the fastening members may have a major axis extending along a length of the fastening member and in the direction crossing the major axis of the one of the connection terminals. The major axis of each of the fastening members may be substantially perpendicular to the major axis of the one of the connection terminals.

According to another embodiment of the present invention, a secondary battery module includes: a plurality of unit batteries, each including an electrode terminal; a plurality of connection terminals threadedly coupled to and electrically connected to the electrode terminals of the unit batteries, each of the connection terminals including a contact surface; a bus bar electrically connecting a first connection terminal of the connection terminals to a second connection terminal of the connection terminals, the first connection terminal being coupled to the electrode terminal of one of the unit batteries, and the second connection terminal being coupled to the electrode terminal of an adjacent one of the unit batteries, the second unit battery being adjacent the first unit battery; and a plurality of fastening members coupling the first and second connection terminals to the bus bar, each of the fastening members including a bolt having a major axis extending in a direction that is substantially perpendicular or oblique to a major axis of a corresponding one of the first and second connection terminals, wherein the bus bar includes at least one contact surface contacting and parallel to the contact surface of each of the first and second connection terminals.

### BRIEF DESCRIPTION OF THE DRAWINGS

The above and other features and aspects of the present invention will become more apparent by describing in detail exemplary embodiments thereof with reference to the attached drawings in which:

FIGS. 1A through 1C are respectively a partially exploded perspective view, a partially exploded detail perspective view, and a partially enlarged sectional view of a secondary battery module according to an embodiment of the present invention;

FIGS. 2A through 2F are sectional views of connection terminals of a secondary battery module according to various embodiments of the present invention;

FIGS. 3A through 3C are respectively a partially exploded perspective view, a partially exploded detail perspective view, and a partially enlarged sectional view of a secondary battery module according to another embodiment of the present invention;

FIGS. 4A through 4C are respectively a partially exploded perspective view, a partially exploded detail perspective view, and a partially enlarged sectional view of a secondary battery module according to still another embodiment of the present invention; and

FIGS. 5A through 5C are respectively a partially exploded perspective view, a partially exploded detail perspective view, and a partially enlarged sectional view of a secondary battery module according to a further embodiment of the present invention.

### DETAILED DESCRIPTION

The present invention will now be described more fully with reference to the accompanying drawings, in which exemplary embodiments of the invention are shown. As those skilled in the art would realize, the described embodiments may be modified in various different ways, all without departing from the spirit or scope of the present invention. The drawings and description are to be regarded as illustrative in nature and not restrictive. Like reference numerals designate like elements throughout the specification.

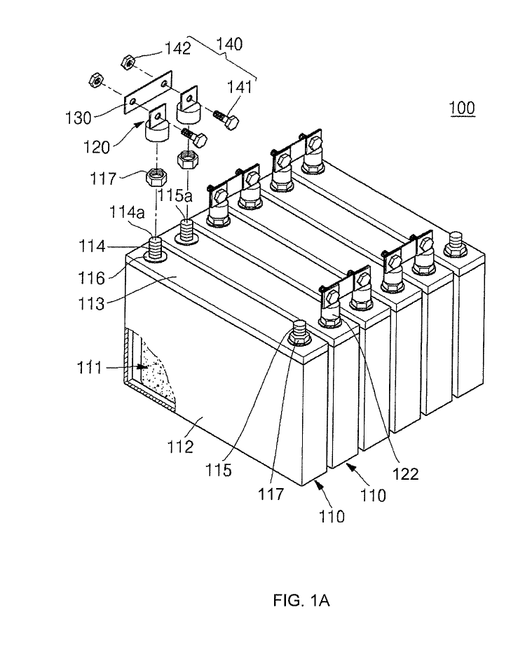

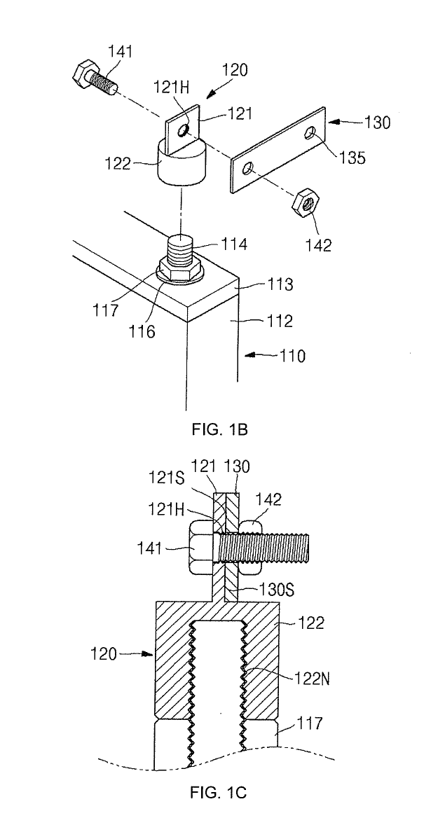

FIG. 1A is a partially exploded perspective view of a secondary battery module according to an embodiment of the present invention; FIG. 1B is a partially exploded detail perspective view of the secondary battery module of FIG. 1A; and FIG. 1C is a partially enlarged sectional view illustrating a combined state of an electrode terminal, a connection terminal, and a bus bar of the secondary battery module of FIG. 1A.

Referring to FIGS. 1A through 1C, a secondary battery module 100 includes unit batteries 110, connection terminals 120, bus bars 130, and fastening members 140 including bolts 141 and nuts 142.

Each of the unit batteries 110 includes an electrode assembly 111 including a positive electrode plate, a negative electrode plate, and a separator interposed therebetween; a case 112 having a receiving space for holding the electrode assembly 111; a cap assembly 113 combined with the case 112 to seal the case 112; and positive and negative terminals 114 and 115 being electrically connected to the positive and negative electrode plates, respectively, and protruding outward from the cap assembly 113.

The case 112 may be made of a conductive metal such as aluminum, aluminum alloy, or nickel-coated steel. The case 112 may be formed in a hexahedral shape or any other suitable shape for retaining the electrode assembly 111 in the receiving space. A hexahedral shape is preferred in one embodiment.

The cap assembly 113 is combined with the case 112 after inserting the electrode assembly 111 in the case 112. Here, the cap assembly 113 may have through-holes through which the positive and negative terminals 114 and 115 are exposed outside the cap assembly 113.

The positive and negative terminals 114 and 115 may be formed in a bolt shape with a threaded outer periphery, and may protrude out at the same height. In this case, the positive and negative terminals 114 and 115 may be exposed outside the cap assembly 113 via a gasket 116 and be secured to the cap assembly 113 by means of a nut 117. The gasket 116 is made of an insulating material, and thus, is responsible for an electrical disconnection between the positive and negative terminals 114 and 115 and the cap assembly 113. In each unit battery 110, two electrode terminals, i.e. the positive and negative terminals 114 and 115, protrude upward from the cap assembly 113 and are spaced from each other by a predetermined distance.

The unit batteries 110 having the above-described structure are arranged in a direction perpendicular to the extending direction of each unit battery, spaced from each other by a distance (e.g., a predetermined distance), and having an orientation wherein the positive and negative terminals 114 and 115 extend upward from the cap assembly 113. As used herein, the phrase the arrangement of the unit batteries 110 “in a direction perpendicular to the extending direction of each unit battery” means that the unit batteries 110 are arranged so that relatively wide lateral surfaces of the unit batteries 110 face each other, as shown in FIG. 1A. That is, the unit batteries 110 are arranged to be spaced from each other by a predetermined distance so that the wide lateral surfaces of the unit batteries 110 face each other. Here, the positive and negative terminals 114 and 115 of the unit batteries 110 are arranged repeatedly in such a way that the positive and negative terminals 114 and 115 of each of the unit batteries 110 are disposed at respective sides of the cap assembly 113 relative to the center of the cap assembly 113. Further, positive and negative terminals 114 and 115 of adjacent ones of the unit batteries 110 are alternately arranged with respect to each other to form terminal rows. Here, a terminal row may be defined as a line along which successive terminals having opposite polarities are aligned.

A positive terminal 114 disposed at a side of each of the unit batteries 110 is electrically connected to a negative terminal 115 disposed at the same side of an adjacent unit battery 110, and a negative terminal 115 disposed at the other side of each of the unit batteries 110 is electrically connected to a positive terminal 114 disposed at the same side of another adjacent unit battery 110. That is, the unit batteries 110 are serially connected to each other in such a way that the positive and negative terminals 114 and 115 of adjacent ones of the unit batteries 110 are alternately arranged with respect to each other to thereby complete the large capacity secondary battery module 100.

The positive and negative terminals 114 and 115 of the unit batteries 110 are electrically and mechanically connected to the connection terminals 120. The mechanical connection may be performed through welding between top surfaces 114a and 115a of the positive and negative terminals 114 and 115 of the unit batteries 110 and the connection terminals 120. The connection terminals 120 may electrically connect the positive and negative terminals 114 and 115 of adjacent ones of the unit batteries 110 via the bus bars 130.

The connection terminals 120 are coupled to the positive and negative terminals 114 and 115 of the unit batteries 110 so as to be electrically connected to the positive and negative terminals 114 and 115, respectively. Here, the connection terminals 120 are coupled to the positive and negative terminals 114 and 115 of the unit batteries 110 so that the major axes of the connection terminals 120 are perpendicular to the extending direction of the unit batteries 110 and are parallel to the major axes of the positive and negative terminals 114 and 115. At the same time, the connection terminals 120 are coupled to the bus bars 130 via the fastening members 140 so that the coupling axes cross or intersect the major axes of the connection terminals 120. For reference, the term “major axis” as used herein with reference to an element refers to an axis parallel to the extending direction of the element.

The connection terminals 120 may include contact portions 121 coupled to the bus bars 130; and coupling portions 122 formed integrally with the contact portions 121 and coupled to the positive and negative terminals 114 and 115 of the unit batteries 110. Here, the connection terminals 120 are structured such that the coupling portions 122 and the contact portions 121 are sequentially aligned along the major axes of the positive and negative terminals 114 and 115.

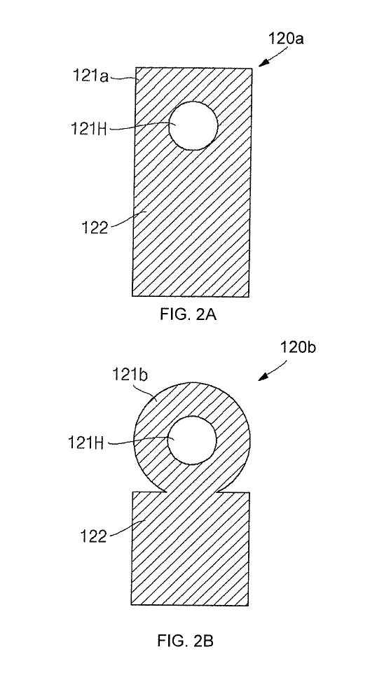

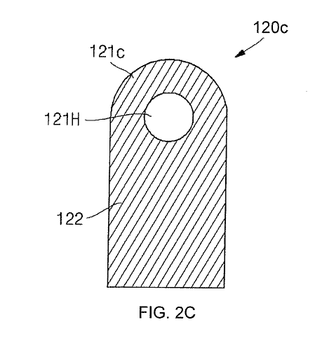

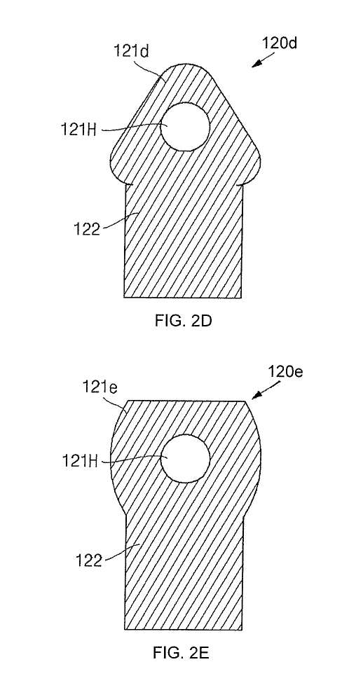

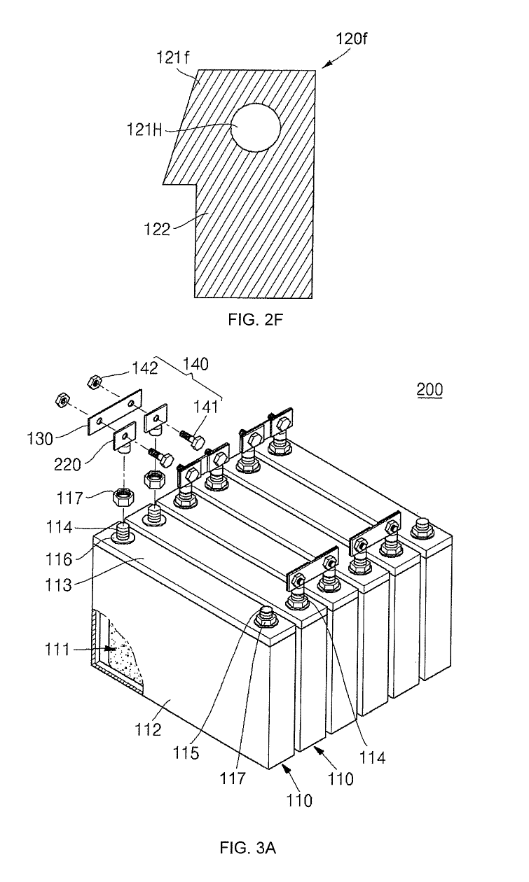

The contact portions 121 may be formed as square or rectangular plates and have flat contact surfaces 121S. The contact portions 121 are coupled to the bus bars 130 via the contact surfaces 121S. As the contact surfaces 121S have a larger area, a contact area between the connection terminals 120 and the bus bars 130 increases, thus ensuring increased current collection efficiency and decreased contact resistance between the connection terminals 120 and the bus bars 130. Parts of the contact portions 121 other than the contact surfaces 121S may have a non-planar configuration. That is, the configuration of the parts of the contact portions 121 other than the contact surfaces 121S is not particularly limited. The contact surfaces 121S may have an approximately square configuration. The configurations of the contact portions 121 and the contact surfaces 121S will be described later in detail with reference to FIGS. 2A through 2F.

Terminal through-holes 121H are formed at the centers of the contact portions 121 and extend through the contact surfaces 121S and surfaces opposite the contact surfaces 121S. That is, the terminal through-holes 121H of the contact portions 121 may be formed to intersect perpendicularly with the major axes of the connection terminals 120. The contact portions 121 are fixedly coupled to the bus bars 130 via the fastening members 140 passing through the terminal through-holes 121H. Thus, the contact portions 121 are coupled to the bus bars 130 by means of the fastening members 140 so that the coupling axes (i.e. the major axes of the fastening members 140) intersect with the major axes of the respective connection terminals 120.

The contact portions 121 are electrically connected to the bus bars 130 in one embodiment by fixedly inserting the fastening members 140 into the terminal through-holes 121H such that the contact surfaces 121S are contacted to the bus bars 130. Here, the terminal through-holes 121H may have internal threaded portions for fixedly receiving the bolts 141 of the fastening members 140.

The coupling portions 122 are coupled to the positive and negative terminals 114 and 115 of the unit batteries 110. Here, the coupling portions 122 may be formed as cap nuts having internal threaded apertures 122N. That is, the bolt-shaped positive and negative terminals 114 and 115 of the unit batteries 110 may be threadably received in the threaded apertures 122N of the coupling portions 122 to connect the coupling portions 122 and the positive and negative terminals 114 and 115. Thus, when the cap nut-shaped coupling portions 122 are coupled to the bolt-shaped positive and negative terminals 114 and 115 of the unit batteries 110, it is possible to control the height of the connection terminals 120 with respect to the positive and negative terminals 114 and 115 by adjusting the number of rotations of the coupling portions 122 rotating about the major axes of the connection terminals 120.

The contact surfaces 121S of the contact portions 121 are rotated, together with the cap nut-shaped coupling portions 122, about the major axes of the connection terminals 120. Therefore, the contact surfaces 121S can be positioned to be parallel to the bus bars 130, and thus, the connection terminals 120 can be coupled to the positive and negative terminals 114 and 115 of the unit batteries 110 in a state wherein the contact surfaces 121S are aligned on the same vertical plane, thereby facilitating a contact between the contact surfaces 121S of the connection terminals 120 and contact surfaces 130S of the bus bars 130.

The coupling portions 122 may be formed as various tubular structures capable of surrounding the positive and negative terminals 114 and 115. Although FIGS. 1A through 1C illustrate that the coupling portions 122 have a cylindrical shape, the present invention is not limited thereto.

A connection terminal 120 coupled to a positive terminal 114 disposed at a side of each unit battery 110 is electrically connected to another connection terminal 120 coupled to a negative terminal 115 disposed at the same side of an adjacent unit battery 110. A connection terminal 120 coupled to a negative terminal 115 disposed at the other side of each unit battery 110 is electrically connected to another connection terminal 120 coupled to a positive terminal 114 disposed at the same side of another adjacent unit battery 110. That is, connection terminals 120 coupled to positive and negative terminals 114 and 115 of each unit battery 110 are connected to connection terminals 120 coupled to negative and positive terminals 115 and 114 of each adjacent unit battery via the bus bars 130.

The bus bars 130 are electrically connected to the connection terminals 120 in such a way that they are closely contacted to the contact surfaces 121S of the contact portions 121 of the connection terminals 120 by the fastening members 140. The bus bars 130 may be formed as a rectangular or approximately bar-like plate.

Bus bar through-holes 135 may be formed on both sides of each of the bus bars 130 and have positions and sizes corresponding to the terminal through-holes 121H of the connection terminals 120. That is, the bus bar through-holes 135 may be formed to intersect perpendicularly with the major axes of the connection terminals 120, like the terminal through-holes 121H.

The bus bars 130 are coupled to the connection terminals 120 via the fastening members 140 including the bolts 141 passing through the bus bar through-holes 135 and the terminal through-holes 121H. Thus, the bus bars 130 are coupled to the connection terminals 120 by means of the fastening members 140 so that the coupling axes intersect with the major axes of the connection terminals 120. Here, the bolts 141 of the fastening members 140 pass through the bus bar through-holes 135 and the terminal through-holes 121H and are threadedly received in the nuts 142. Thus, the bus bars 130 are electrically connected to the connection terminals 120 in such a way that they are closely contacted to the contact surfaces 121S of the connection terminals 120 by means of the fastening members 140. Here, as the size of the bus bars 130 increases, a contact area between the bus bars 130 and the contact surfaces 121S increases, thus ensuring improved current collection efficiency.

The bolts 141 of the fastening members 140 pass through the terminal through-holes 121H of the connection terminals 120 and the bus bar through-holes 135 of the bus bars 130 so as to be fixedly mounted therein. The bolts 141 of the fastening members 140 pass through the terminal through-holes 121H and the bus bar through-holes 135 formed to be perpendicular to the major axes of the connection terminals 120, and thus, the coupling axes of the fastening members 140 intersect with the major axes of the connection terminals 120.

The fastening members 140 include the bolts 141 passing through the terminal through-holes 121H formed through the contact portions 121 of the connection terminals 120 and the bus bar through-holes 135 formed through the bus bars 130; and the nuts 142 coupled to the bolts 141 to fasten the connection terminals 120 and the bus bars 130.

The bolts 141 of the fastening members 140 are positioned so that the major axes of the bolts 141 are perpendicular to the major axes of the connection terminals 120. Thus, when the bolts 141 are rotatably inserted into the terminal through-holes 121H of the connection terminals 120 and the bus bar through-holes 135 of the bus bars 130, the positive and negative terminals 114 and 115 of the unit batteries 110 electrically connected to the connection terminals 120 are prevented or substantially prevented from rotating due to the rotation torque of the bolts 141 exerted on the connection terminals 120.

Therefore, in the secondary battery module 100, the connection terminals 120 may be coupled to the bus bars 130 by applying a sufficiently high pressure to the fastening members 140 while maintaining a coupled state between the positive and negative terminals 114 and 115 of the unit batteries 110 and the connection terminals 120. As such, the connection terminals 120 and the bus bars 130 may be coupled to each other under a sufficiently high pressure, thus resulting in decreased contact resistance between the contact surfaces 121S of the connection terminals 120 and the contact surfaces 130S of the bus bars 130.

Moreover, the coupling portions 122 of the connection terminals 120 may be formed in a cap screw configuration, and thus, the bolt-shaped positive and negative terminals 114 and 115 of the unit batteries 110 may be threadably received in the coupling portions 122. This allows for adjustability of the height of the connection terminals 120 with respect to the positive and negative terminals 114 and 115 and to position the contact surfaces 121S of the connection terminals 120 to be parallel to the bus bars 130, thereby facilitating a contact between the contact surfaces 121S of the connection terminals 120 and the contact surfaces 130S of the bus bars 130, resulting in decreased contact resistance and increased current collection efficiency.

FIGS. 2A through 2F are sectional views illustrating various alternative exemplary embodiments of the connection terminals 120 of the secondary battery module 100 shown in FIGS. 1A through 1C. FIGS. 2A through 2F are views taken along the major axes of connection terminals 120a through 120f that are parallel to contact surfaces of contact portions 121a through 121f. The connection terminals 120a through 120f include the contact portions 121a through 121f and coupling portions 122 formed integrally with the contact portions 121a through 121f. Terminal through-holes 121H are formed at the centers of the contact portions 121a through 121f to receive bolts (e.g., bolts 141 of FIG. 1A) of fastening members (e.g., fastening members 140 of FIG. 1A). The coupling portions 122 and the terminal through-holes 121H formed at the contact portions 121a through 121f are as described above with reference to FIGS. 1A through 1C, and thus, only the configurations of the contact portions 121a through 121f will now be described in detail.

Referring to FIG. 2A, the connection terminal 120a includes the contact portion 121a having a square section and the coupling portion 122 formed integrally with the contact portion 121a. FIG. 2A illustrates that the coupling portion 122 is formed at a side of the contact portion 121a, but the present invention is not limited thereto. That is, the coupling portion 122 may also be formed at a corner of the contact portion 121a. The section of the contact portion 121a corresponds to a contact surface contacting with a bus bar (e.g., bus bar 130 of FIG. 1A), and thus, the contact surface may also have a square shape. As the contact portion 121a has a larger contact surface, the connection between the contact surface and the bus bar can lead to increased current collection efficiency. FIG. 2A illustrates that the contact portion 121a of the connection terminal 120a has a square section, but the contact portion 121a may have various sectional shapes such as a regular polygon having a plurality of sides and corners.

Referring to FIG. 2B, the connection terminal 120b includes the contact portion 121b having a circular section and the coupling portion 122 formed integrally with the contact portion 121b. Here, the section of the contact portion 121b corresponds to a contact surface contacting with a bus bar (e.g., bus bar 130 of FIG. 1A), and thus, the contact surface may also have a circular shape. As the contact portion 121b has a larger contact surface, the connection between the contact surface and the bus bar can lead to increased current collection efficiency. FIG. 2B illustrates that the contact portion 121b of the connection terminal 120b has a circular section, but the contact portion 121b may have various sectional shapes such as an oval shape or a concavely or convexly curved polygonal shape.

Referring to FIG. 2C, the connection terminal 120c includes the contact portion 121c having a semi-circular section and the coupling portion 122 formed integrally with the contact portion 121c. FIG. 2C illustrates that the coupling portion 122 is formed at a straight side of the contact portion 121c, but the present invention is not limited thereto. That is, the coupling portion 122 may also be formed at a convexly curved side of the contact portion 121c. The section of the contact portion 121c corresponds to a contact surface contacting with a bus bar (e.g., bus bar 130 of FIG. 1A), and thus, the contact surface may also have a semi-circular shape. As the contact portion 121c has a larger contact surface, the connection between the contact surface and the bus bar can lead to increased current collection efficiency. FIG. 2C illustrates that the contact portion 121c of the connection terminal 120c has a semi-circular section, but the contact portion 121c may have various sectional shapes such as a semi-oval shape having a straight side and a convexly curved side.

Referring to FIG. 2D, the connection terminal 120d includes the contact portion 121d having a triangular section with rounded corners and the coupling portion 122 formed integrally with the contact portion 121d. FIG. 2D illustrates that the coupling portion 122 is formed at a straight side of the contact portion 121d, but the present invention is not limited thereto. That is, the coupling portion 122 may also be formed at a rounded corner of the contact portion 121d. The section of the contact portion 121d corresponds to a contact surface contacting with a bus bar (e.g., bus bar 130 of FIG. 1A), and thus, the contact surface may also have a triangular shape with rounded corners. As the contact portion 121d has a larger contact surface, the connection between the contact surface and the bus bar can lead to increased current collection efficiency. FIG. 2D illustrates that the contact portion 121d of the connection terminal 120d has a triangular section with rounded corners, but the contact portion 121d may also have various sectional shapes such as a polygon with a plurality of sides and rounded corners.

Referring to FIG. 2E, the connection terminal 120e includes the contact portion 121e having a sectional shape with two opposite straight sides and two convexly curved sides connecting the two straight sides, and the coupling portion 122 formed integrally with the contact portion 121e. FIG. 2E illustrates that the coupling portion 122 is formed at a straight side of the contact portion 121e, but the present invention is not limited thereto. That is, the coupling portion 122 may also be formed at a convexly curved side. The section of the contact portion 121e corresponds to a contact surface contacting with a bus bar (e.g., bus bar 130 of FIG. 1A), and thus, the contact surface may also have the same shape as the section of the contact portion 121e. As the contact portion 121e has a larger contact surface, the connection between the contact surface and the bus bar can lead to increased current collection efficiency. FIG. 2E illustrates that the contact portion 121e of the connection terminal 120e has a sectional shape with two opposite straight sides and two convexly curved sides connecting the two straight sides, but the contact portion 121e may have various sectional shapes such as a shape with a plurality of straight sides and convexly curved sides.

Referring to FIG. 2F, the connection terminal 120f includes the contact portion 121f having an irregular square section and the coupling portion 122 formed integrally with the contact portion 121f. FIG. 2F illustrates that the coupling portion 122 is formed at a side of the contact portion 121f, but the present invention is not limited thereto. That is, the coupling portion 122 may also be formed at a corner of the contact portion 121f. The section of the contact portion 121f corresponds to a contact surface contacting with a bus bar (e.g., bus bar 130 of FIG. 1A), and thus, the contact surface may also have an irregular square shape. As the contact portion 121f has a larger contact surface, the connection between the contact surface and the bus bar can lead to increased current collection efficiency. FIG. 2F illustrates that the contact portion 120f of the connection terminal 120f has a square section that is asymmetric with respect to the major axis of the coupling portion 122, but the contact portion 120f may have various sectional shapes such as an irregular polygon with a plurality of sides and corners. Here, the terminal through-hole 121H may be formed at a center of gravity of the contact portion 121f.

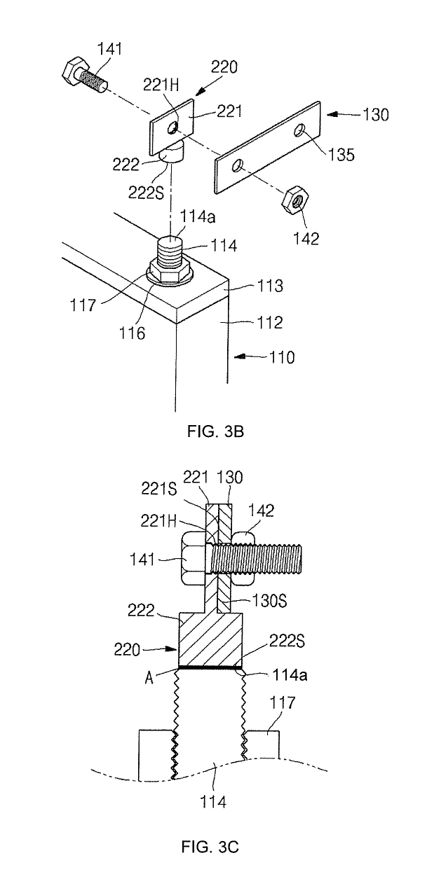

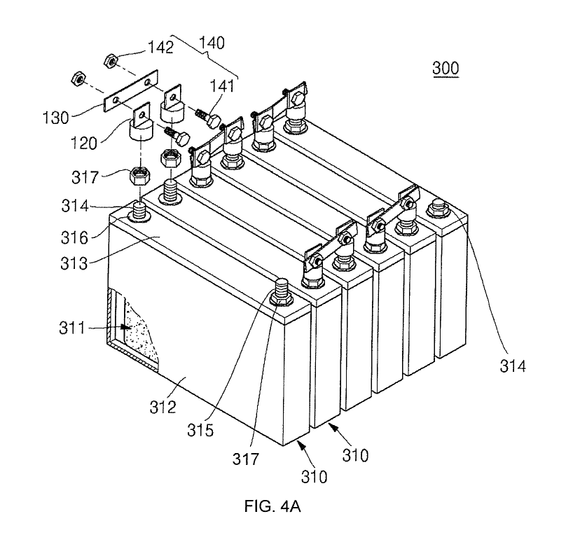

FIG. 3A is a partially exploded perspective view of a secondary battery module according to another embodiment of the present invention; FIG. 3B is a partially exploded detail perspective view of the secondary battery module of FIG. 3A; and FIG. 3C is a partially enlarged sectional view illustrating a combined state of an electrode terminal, a connection terminal, and a bus bar of the secondary battery module of FIG. 3A.

Referring to FIGS. 3A through 3C, a secondary battery module 200 includes unit batteries 110, connection terminals 220, bus bars 130, and fastening members 140. The unit batteries 110, the bus bars 130, and the fastening members 140 of the secondary battery module 200 are the same as those of the secondary battery module 100 shown in FIGS. 1A through 1C. Thus, the secondary battery module 200 will be described hereinafter with respect to the connection terminals 220 that are different from the connection terminals 120 of the secondary battery module 100.

The connection terminals 220 are coupled to positive and negative terminals 114 and 115 of the unit batteries 110 so as to be electrically connected to the positive and negative terminals 114 and 115. Here, the connection terminals 220 are coupled to the positive and negative terminals 114 and 115 so that the major axes of the connection terminals 220 are perpendicular to a lengthwise direction of the unit batteries 110 and a direction along which the unit batteries 110 are spaced from one another, and are parallel to the major axes of the positive and negative terminals 114 and 115. At the same time, the connection terminals 220 are coupled to the bus bars 130 by means of the fastening members 140 so that the coupling axes (i.e. the major axes of the fastening members 140) intersect with the major axes of the connection terminals 220.

The connection terminals 220 include contact portions 221 coupled to the bus bars 130; and coupling portions 222 formed integrally with the contact portions 221 and coupled to the positive and negative terminals 114 and 115 of the unit batteries 110. Here, the connection terminals 220 are structured such that the coupling portions 222 and the contact portions 221 are sequentially arranged along the major axes of the positive and negative terminals 114 and 115.

The contact portions 221 may be formed as square or rectangular plates and have flat contact surfaces 221S. The contact portions 221 are coupled to the bus bars 130 via the contact surfaces 221S. Preferably, in one embodiment, the contact surfaces 221S of the contact portions 221 have a larger area than sections of the coupling portions 222 taken along the major axes of the connection terminals 220. As the contact surfaces 221S have a larger area, a contact area between the connection terminals 220 and the bus bars 130 increases, and thus, the connection between connection terminals 220 and the bus bars 130 leads to increased current collection efficiency and decreased contact resistance. The contact surfaces 221S may have a circular shape or a polygonal shape with straight sides, convexly curved sides, or a combination thereof. Parts of the contact portions 221 other than the contact surfaces 221S may have a non-planar configuration. That is, the configuration of the parts of the contact portions 221 other than the contact surfaces 221S is not particularly limited. The contact surfaces 221S may have an approximately square configuration. The sections of the contact portions 221 and the contact surfaces 221S may have a circular shape or a polygonal shape with straight sides, convexly curved sides, or a combination thereof, as described above with reference to FIGS. 2A through 2F.

Terminal through-holes 221H may be formed at centers of the contact portions 221 and extend through the contact surfaces 221S and surfaces opposite the contact surfaces 221S. That is, the terminal through-holes 221H of the contact portions 221 may be formed to intersect perpendicularly with the major axes of the connection terminals 220. The contact portions 221 are fixedly coupled to the bus bars 130 via bolts 141 of the fastening members 140 that are inserted into the terminal through-holes 221H. Thus, the contact portions 221 are coupled to the bus bars 130 by means of the fastening members 140 so that the coupling axes intersect with the major axes of the connection terminals 220.

The contact portions 221 may be electrically connected to the bus bars 130 by inserting the bolts 141 of the fastening members 140 into the terminal through-holes 221H such that the contact surfaces 221S are contacted to the bus bars 130. Here, the terminal through-holes 221H may have internal threaded portions for threadably receiving the bolts 141 of the fastening members 140.

The coupling portions 222 are coupled to the positive and negative terminals 114 and 115 of the unit batteries 110. Here, bottom surfaces 222S of the coupling portions 222 may be joined to top surfaces 114a and 115a of the positive and negative terminals 114 and 115 through welding (indicated by “A” in FIG. 3C). The connection terminals 220 may be welded to the positive and negative terminals 114 and 115 of the unit batteries 110 in a configuration wherein the contact surfaces 221S are positioned to be parallel to the bus bars 130 through adjustment of the spatial orientation of the contact surfaces 221S using a jig. Thus, the connection terminals 220 can be coupled to the positive and negative terminals 114 and 115 of the unit batteries 110 in a state wherein the contact surfaces 221S of the connection terminals 220 are aligned on the same vertical plane, thereby facilitating a contact between the contact surfaces 221S of the connection terminals 220 and contact surfaces 130S of the bus bars 130.

The coupling portions 222 may be formed in a cylindrical shape with the same diameter as the top surfaces 114a and 115a of the positive and negative terminals 114 and 115. However, the present invention is not limited thereto, and the coupling portions 222 may have various pillar shapes for welding to the positive and negative terminals 114 and 115.

A connection terminal 220 coupled to a positive terminal 114 disposed at a side of each unit battery 110 is electrically connected to another connection terminal 220 coupled to a negative terminal 115 disposed at the same side of an adjacent unit battery 110. A connection terminal 220 coupled to a negative terminal 115 disposed at the other side of each unit battery 110 is electrically connected to another connection terminal 220 coupled to a positive terminal 114 disposed at the same side of another adjacent unit battery 110. That is, connection terminals 120 coupled to positive and negative terminals 114 and 115 of each unit battery 110 are connected to connection terminals 120 coupled to negative and positive terminals 115 and 114 of each adjacent unit battery 110 via the bus bars 130.

When the bolts 141 of the fastening members 140 having major axes perpendicular to the major axes of the connection terminals 220 are rotatably inserted into the terminal through-holes 221H of the connection terminals 220 and bus bar through-holes 135 of the bus bars 130, the positive and negative terminals 114 and 115 of the unit batteries 110 coupled to the connection terminals 220 are prevented or substantially prevented from rotating due to the rotation torque of the bolts 141 exerted on the connection terminals 220.

Therefore, in the secondary battery module 200, the connection terminals 220 may be coupled to the bus bars 130 by applying a sufficiently high pressure to the fastening members 140 while maintaining a coupled state between the positive and negative terminals 114 and 115 of the unit batteries 110 and the connection terminals 220. As such, the connection terminals 220 and the bus bars 130 are coupled to each other under a sufficiently high pressure, thus ensuring decreased contact resistance between the contact surfaces 221S of the connection terminals 220 and the contact surfaces 130S of the bus bars 130.

Moreover, the connection terminals 220 may be coupled to the positive and negative terminals 114 and 115 of the unit batteries 110 through welding in a state wherein the contact surfaces 221S of the connection terminals 220 are positioned to be parallel to the bus bars 130 through adjustment of the spatial orientation of the contact surfaces 221S using a jig, thereby facilitating a contact between the contact surfaces 221S of the connection terminals 220 and the contact surfaces 130S of the bus bars 130, resulting in decreased contact resistance and increased current collection efficiency.

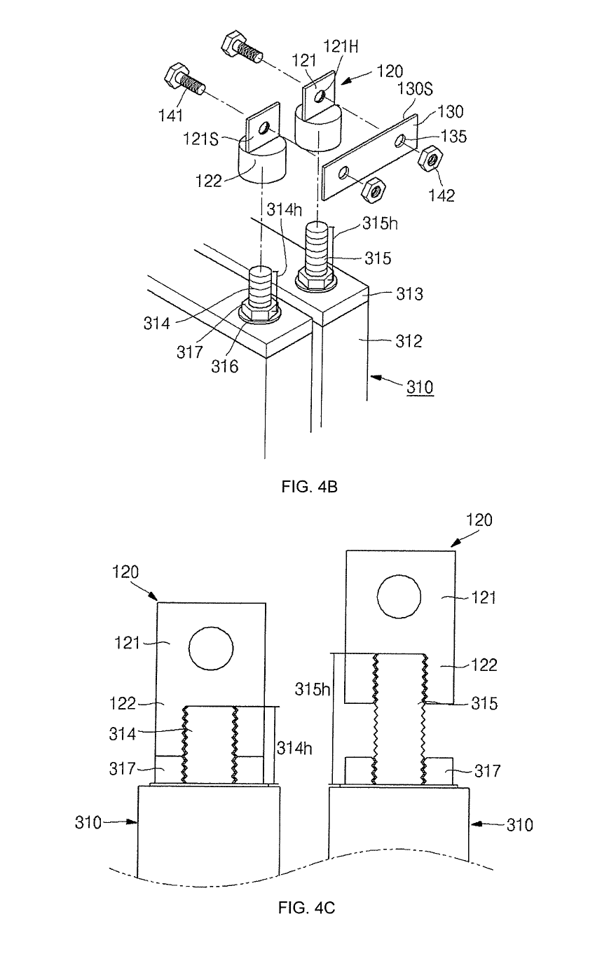

FIG. 4A is a partially exploded perspective view of a secondary battery module according to still another embodiment of the present invention; FIG. 4B is a partially exploded detail perspective view of the secondary battery module of FIG. 4A; and FIG. 4C is a partially enlarged sectional view illustrating a combined state of an electrode terminal, a connection terminal, and a bus bar of the secondary battery module of FIG. 4A.

Referring to FIGS. 4A through 4C, a secondary battery module 300 includes unit batteries 310, connection terminals 120, bus bars 130, and fastening members 140. The connection terminals 120, the bus bars 130, and the fastening members 140 of the secondary battery module 300 are the same as those of the secondary battery module 100 shown in FIGS. 1A through 1C. Thus, the secondary battery module 300 will be described hereinafter with respect to the unit batteries 310 that are different from the unit batteries 110 of the secondary battery module 100.

Each of the unit batteries 310 includes an electrode assembly 311 including a positive electrode plate, a negative electrode plate, and a separator interposed therebetween; a case 312 having a receiving space for holding the electrode assembly 311; a cap assembly 313 combined with the case 312 to seal the case 312; and positive and negative terminals 314 and 315 being electrically connected to the positive and negative electrode plates, respectively, and protruding outward from the cap assembly 313.

The case 312 may be made of a conductive metal such as aluminum, aluminum alloy, or nickel-coated steel. The case 312 may be formed in a hexahedral shape or any other suitable shape for retaining the electrode assembly 311 in the receiving space. A hexahedral shape is preferred in one embodiment.

Each of the positive and negative terminals 314 and 315 may be formed in a bolt shape having a threaded outer periphery. FIGS. 4A through 4C illustrate that the height 314h of the positive terminals 314 extending outward from the cap assembly 313 is lower than the height 315h of the negative terminals 315 extending outward from the cap assembly 313. However, the height 314h of the positive terminals 314 may alternatively be higher than the height 315h of the negative terminals 315. That is, the height 314h of the positive terminals 314 may be different from the height 315h of the negative terminals 315. As such, the unit batteries 310 are structured such that the height 314h of the positive terminals 314 is different from the height 315h of the negative terminals 315, and thus, it is possible to easily distinguish the positive terminals 314 and the negative terminals 315 from each other, thus facilitating arrangement of the unit batteries 310 when manufacturing the secondary battery module 300 through serial connection between the unit batteries 310.

The bolt-shaped positive and negative terminals 314 and 315 may be threadedly secured into nuts 317 at ends that are exposed outside the cap assembly 313 with a gasket 316 between the cap assembly 313 and each of the nuts 317. The positive and negative terminals 314 and 315 of the unit batteries 310 protrude outward from the cap assembly 313 and are spaced from each other by a predetermined distance.

The unit batteries 310 having the above-described structure are arranged in a direction perpendicular to the extending direction of each unit battery, spaced from each other by a predetermined distance, and oriented such that the positive and negative terminals 314 and 315 extend upward from the cap assembly 313. As used herein, the phrase the arrangement of the unit batteries 310 “in a direction perpendicular to the extending direction of each unit battery” means that the unit batteries 310 are arranged so that relatively wide lateral surfaces of the unit batteries 310 face each other, as shown in FIG. 4A. That is, the unit batteries 310 may be arranged to be spaced from each other by a distance (e.g., a predetermined distance) so that the wide lateral surfaces of the unit batteries 310 face each other. Here, the positive and negative terminals 314 and 315 of the unit batteries 310 are arranged repeatedly such that the positive and negative terminals 114 and 115 of each unit battery 310 are disposed at respective sides of the cap assembly 313 relative to the center of the cap assembly 313. Further, the positive and negative terminals 314 and 315 of adjacent ones of the unit batteries 310 are alternately arranged with respect to each other to form terminal rows. Here, a terminal row may be defined as a line along which successive terminals having opposite polarities are aligned.

A positive terminal 314 disposed at a side of each unit battery 310 is electrically connected to a negative terminal 315 disposed at the same side of an adjacent unit battery 310, and a negative terminal 315 disposed at the other side of each unit battery 310 is electrically connected to a positive terminal 314 disposed at the same side of another adjacent unit battery 310. That is, the unit batteries 310 are serially connected to each other so that the positive and negative terminals 314 and 315 of adjacent ones of the unit batteries 310 are alternately arranged with respect to each other to thereby form the large capacity secondary battery module 300.

The positive and negative terminals 314 and 315 of the unit batteries 310 may be electrically and mechanically connected to the cap nut-shaped connection terminals 120. The connection terminals 120 may electrically connect the positive and negative terminals 314 and 315 of adjacent ones of the unit batteries 310 via the bus bars 130. When the cap nut-shaped coupling portions 122 are coupled to the bolt-shaped positive and negative terminals 314 and 315 of the unit batteries 310, it is possible to control the height of the connection terminals 120 with respect to the positive and negative terminals 314 and 315 by adjusting the number of rotations of the coupling portions 122 rotating about the major axes of the connection terminals 120. Contact surfaces 121S of contact portions 121 are rotated, together with the cap nut-shaped coupling portions 122, about the major axes of the connection terminals 120. Thus, the contact surfaces 121S can be positioned to be parallel to the bus bars 130.

When bolts 141 having major axes perpendicular to the major axes of the connection terminals 120 are rotatably inserted into terminal through-holes 121H of the connection terminals 120 and bus bar through-holes 135 of the bus bars 130, the positive and negative terminals 314 and 315 of the unit batteries 310 electrically connected to the connection terminals 120 are prevented or substantially prevented from rotating due to the rotation torque of the bolts 141 exerted on the connection terminals 120.

Therefore, in the secondary battery module 300, the connection terminals 120 may be coupled to the bus bars 130 by applying a sufficiently high pressure to the fastening members 140 while maintaining a coupled state between the positive and negative terminals 314 and 315 of the unit batteries 310 and the connection terminals 120. As such, the connection terminals 120 and the bus bars 130 may be coupled to each other under a sufficiently high pressure, thus providing decreased contact resistance between the contact surfaces 121S of the connection terminals 120 and contact surfaces 130S of the bus bars 130.

Moreover, the secondary battery module 300 is structured such that the height 314h of the positive terminals 314 extending outward from the cap assembly 313 is different from the height 315h of the negative terminals 315 extending outward from the cap assembly 313, thus enabling easy arrangement of the unit batteries 310 when manufacturing the secondary battery module 300 through serial connection between the unit batteries 310.

In addition, the coupling portions 122 of the connection terminals 120 are formed in a cap screw configuration, and thus, the bolt-shaped positive and negative terminals 314 and 315 of the unit batteries 310 are threadably secured into the coupling portions 122. This enables the height of the connection terminals 120 to be adjusted with respect to the positive and negative terminals 314 and 315 and also enables the contact surfaces 121S of the connection terminals 120 to be positioned parallel to the bus bars 130, thereby facilitating a contact between the contact surfaces 121S of the connection terminals 120 and the contact surfaces 130S of the bus bars 130, resulting in decreased contact resistance and increased current collection efficiency.

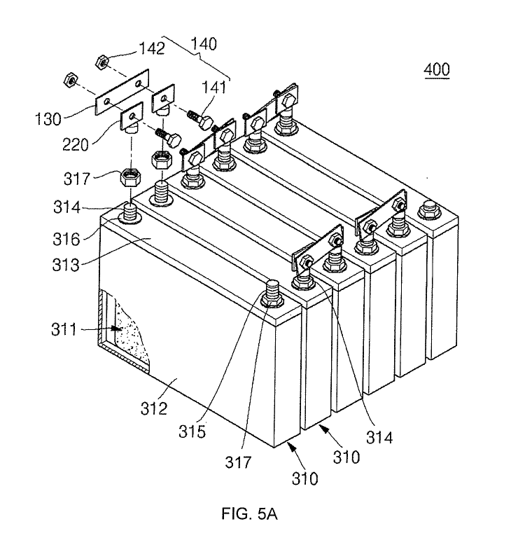

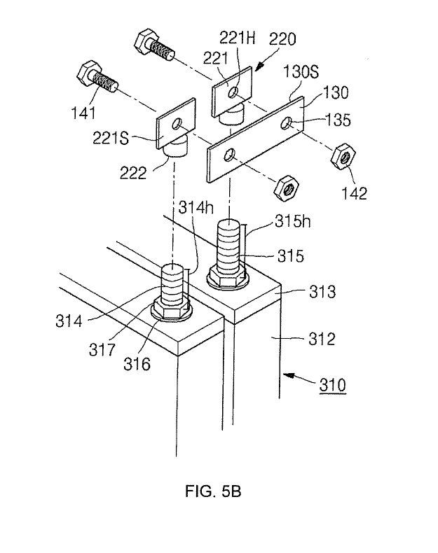

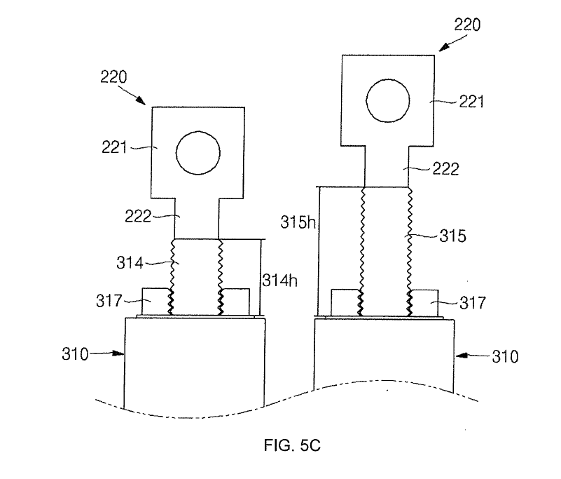

FIG. 5A is a partially exploded perspective view of a secondary battery module according to a further embodiment of the present invention; FIG. 5B is a partially exploded detail perspective view of the secondary battery module of FIG. 5A; and FIG. 5C is a partially enlarged sectional view illustrating a combined state of an electrode terminal, a connection terminal, and a bus bar of the secondary battery module of FIG. 5A.

Referring to FIGS. 5A through 5C, a secondary battery module 400 includes unit batteries 310, connection terminals 220, bus bars 130, and fastening members 140. The connection terminals 220, the bus bars 130, and the fastening members 140 of the secondary battery module 400 are the same as those of the secondary battery module 200 shown in FIGS. 3A through 3C. Thus, the secondary battery module 400 will be described hereinafter with respect to the unit batteries 310 that are different from the unit batteries 110 of the secondary battery module 200.

Each of the unit batteries 310 includes an electrode assembly 311 including a positive electrode plate, a negative electrode plate, and a separator interposed therebetween; a case 312 having a receiving space for holding the electrode assembly 311; a cap assembly 313 combined with the case 312 to seal the case 312; and positive and negative terminals 314 and 315 being electrically connected to the positive and negative electrode plates, respectively, and protruding outward from the cap assembly 313.

The case 312 may be made of a conductive metal such as aluminum, aluminum alloy, or nickel-coated steel. The case 312 may be formed in a hexahedral shape or any other suitable shape for retaining the electrode assembly 311 in the receiving space. A hexahedral shape is preferred in one embodiment.

The positive and negative terminals 314 and 315 may be formed having a bolt shape with a threaded outer periphery. FIGS. 5A through 5C illustrate that the height 314h of the positive terminals 314 extending outward from the cap assembly 313 is lower than the height 315h of the negative terminals 315 extending outward from the cap assembly 313. However, the height 314h of the positive terminals 314 may alternatively be higher than the height 315h of the negative terminals 315. That is, the height 314h of the positive terminals 314 may be different from the height 315h of the negative terminals 315. As such, the unit batteries 310 are structured such that the height 314h of the positive terminals 314 is different from the height 315h of the negative terminals 315, and thus, it is possible to easily distinguish the positive terminals 314 and the negative terminals 315 from each other, thus enabling easy arrangement of the unit batteries 310 when manufacturing the secondary battery module 300 through serial connection between the unit batteries 310.

The bolt-shaped positive and negative terminals 314 and 315 may be threadably secured into nuts 317 near ends that are exposed outside the cap assembly 313 with a gasket 316 sandwiched between the cap assembly 313 and each of the nuts 317. The positive and negative terminals 314 and 315 of the unit batteries 310 protrude outward from the cap assembly 313 and are spaced from each other by a predetermined distance.

The unit batteries 310 having the above-described structure are arranged in a direction perpendicular to a lengthwise direction of each unit battery, spaced from each other by a predetermined distance, and oriented such that the positive and negative terminals 314 and 315 extend upward from the cap assembly 313. That is, the unit batteries 310 are arranged so that relatively wide lateral surfaces of the unit batteries 310 face each other, as shown in FIG. 5A, and the unit batteries 310 are spaced from each other by a predetermined distance. Here, the positive and negative terminals 314 and 315 of the unit batteries 310 are arranged repeatedly in such a way that positive and negative terminals 114 and 115 of each unit battery are disposed at both sides of the cap assembly 313 relative to the center of the cap assembly 313. That is, positive and negative terminals 314 and 315 of adjacent ones of the unit batteries 310 are alternately arranged with respect to each other to form terminal rows. Here, a terminal row may be defined as a line along which successive terminals having opposite polarities are aligned.

A positive terminal 314 disposed at a side of each unit battery 310 is electrically connected to a negative terminal 315 disposed at the same side of an adjacent unit battery 310, and a negative terminal 315 disposed at the other side of each unit battery 310 is electrically connected to a positive terminal 314 disposed at the same side of another adjacent unit battery 310. That is, the unit batteries 310 are serially connected to each other so that the positive and negative terminals 314 and 315 of adjacent ones of the unit batteries 310 are alternately arranged with respect to each other to thereby form the large capacity secondary battery module 400.

The positive and negative terminals 314 and 315 of the unit batteries 310 are electrically and mechanically connected to the connection terminals 220. Such electrical and mechanical connection may be achieved through welding between top surfaces of the positive and negative terminals 314 and 315 of the unit batteries 310 and the connection terminals 220. At this time, the connection terminals 220 may be welded to the positive and negative terminals 314 and 315 of the unit batteries 310 in a state wherein contact surfaces 221S of the connection terminals 220 are positioned to be parallel to the bus bars 130 through adjustment of the spatial orientation of the contact surfaces 221S using a jig. Therefore, it is possible to facilitate a contact between the contact surfaces 221S of the connection terminals 220 and contact surfaces 130S of the bus bars 130, resulting in decreased contact resistance and increased current collection efficiency.

When bolts 141 having major axes perpendicular to the major axes of the connection terminals 220 are rotatably inserted into terminal through-holes 221H of the connection terminals 220 and bus bar through-holes 135 of the bus bars 130, the positive and negative terminals 314 and 315 of the unit batteries 310 electrically connected to the connection terminals 220 are prevented or substantially prevented from rotating due to the rotation torque of the bolts 141 exerted on the connection terminals 220.

Therefore, in the secondary battery module 400, the connection terminals 220 may be coupled to the bus bars 130 by applying a sufficiently high pressure to the fastening members 140 while maintaining a coupled state between the positive and negative terminals 314 and 315 of the unit batteries 310 and the connection terminals 220. As such, the connection terminals 220 and the bus bars 130 may be coupled to each other under a sufficiently high pressure, thus providing decreased contact resistance between the contact surfaces 221S of the connection terminals 220 and the contact surfaces 130S of the bus bars 130.

Moreover, the secondary battery module 400 is structured such that the height 314h of the positive terminals 314 extending outward from the cap assembly 313 is different from the height 315h of the negative terminals 315 extending outward from the cap assembly 313, thus enabling easy arrangement of the unit batteries 310 when manufacturing the secondary battery module 300 through serial connection between the unit batteries 310.

In addition, the connection terminals 220 may be coupled to the positive and negative terminals 314 and 315 of the unit batteries 310 through welding in a state wherein the contact surfaces 221S of the connection terminals 220 are positioned to be parallel to the bus bars 130 through adjustment of the spatial orientation of the contact surfaces 221S using a jig, thereby facilitating a contact between the contact surfaces 221S of the connection terminals 220 and the contact surfaces 130S of the bus bars 130, resulting in decreased contact resistance and increased current collection efficiency.

As is apparent from the above description, according to the embodiments of the secondary battery module, the major axis of a connection terminal intersects with a coupling axis between the connection terminal and a fastening member. Therefore, it is possible to couple the connection terminal to a bus bar by applying a sufficiently high pressure to the fastening member while maintaining a coupled state between an electrode terminal of a unit battery and the connection terminal, resulting in decreased contact resistance between the connection terminal and the bus bar.

Moreover, the inventive secondary battery may be structured such that the heights of positive terminals of unit batteries are different from those of negative terminals of the unit batteries, thus enabling easy distinction between the positive and negative terminals when manufacturing the secondary battery through arrangement and serial connection between the unit batteries.

In addition, it is possible to control the spatial orientation of contact surfaces of connection terminals so that the contact surfaces of the connection terminals are contacted in parallel to a contact surface of a bus bar when the connection terminals are coupled to electrode terminals of unit batteries, thus ensuring increased current collection efficiency and decreased contact resistance between the contact surfaces of the connection terminals and the bus bar.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A secondary battery module comprising:
a plurality of unit batteries comprising electrode terminals;
a plurality of connection terminals, each coupled to and electrically connected to a respective one of the electrode terminals of the unit batteries, each of the connection terminals having a major axis extending along a length of the connection terminal;
a bus bar electrically connecting connection terminals of the plurality of connection terminals; and
a plurality of fastening members fastening the connection terminals to the bus bar, each of the fastening members extending in a direction crossing the major axis of one of the connection terminals,
wherein the bus bar comprises at least one contact surface parallel to a contact surface of each of the connection terminals.

2. The secondary battery module of claim 1, wherein the connection terminals comprise:
contact portions coupled to the bus bar; and
coupling portions integral with the contact portions and coupled to the electrode terminals of the unit batteries.

3. The secondary battery module of claim 2, wherein the contact portions of the connection terminals comprise the contact surfaces of the connection terminals, the contact surfaces being substantially flat and contacting the bus bar.

4. The secondary battery module of claim 3, wherein the at least one contact surface of the bus bar is substantially flat and closely contacts the contact surfaces of the connection terminals.

5. The secondary battery module of claim 3, wherein the contact surfaces of the connection terminals have at least one shape selected from the group consisting of a circular shape, a polygonal shape with a plurality of straight sides, a polygonal shape with a plurality of convexly curved sides, and a polygonal shape with a combination of a plurality of straight sides and convexly curved sides.

6. The secondary battery module of claim 3, wherein the coupling portions of the connection terminals are welded to the electrode terminals of the unit batteries.

7. The secondary battery module of claim 2, wherein the electrode terminals of the unit batteries have a threaded bolt shape.

8. The secondary battery module of claim 7, wherein the coupling portions of the connection terminals have internal threaded apertures, and the electrode terminals are threadedly inserted into the threaded apertures of the coupling portions, the connection terminals having a height relative to the electrode terminals, and wherein the contact portions of the connection terminals comprise the contact surfaces of the connection terminals.

9. The secondary battery module of claim 8, wherein the height of each of the connection terminals is adjustable via threaded rotation of the connection terminal relative to a corresponding one of the electrode terminals.

10. The secondary battery module of claim 2, wherein the contact portions of the connection terminals have terminal through-holes extending therethrough and receiving the fastening members coupling the connection terminals and the bus bar.

11. The secondary battery module of claim 10, wherein the bus bar has bus bar through-holes extending therethrough and corresponding to the terminal through-holes of the connection terminals for coupling the connection terminals and the bus bar.

12. The secondary battery module of claim 11, wherein the bus bar has two bus bar through-holes spaced from each other by a same distance as a distance between electrode terminals of two adjacent ones of the unit batteries.

13. The secondary battery module of claim 11, wherein each of the fastening members comprises:
a bolt extending through the terminal through-hole at the contact portion of one of the connection terminals and one of the bus bar through-holes; and
a nut coupled to the bolt for fastening the one of the connection terminals to the bus bar.

14. The secondary battery module of claim 1, wherein the electrode terminals of the unit batteries comprise positive terminals and negative terminals.

15. The secondary battery module of claim 14, wherein the positive terminals of the unit batteries have a different height than the negative terminals of the unit batteries.

16. The secondary battery module of claim 14, wherein the bus bar electrically connects a positive terminal of one of the unit batteries and a negative terminal of an adjacent one of the unit batteries to serially connect the one unit battery and the adjacent unit battery.

17. The secondary battery module of claim 1, wherein the unit batteries have a box shape.

18. The secondary battery module of claim 1, wherein each of the fastening members has a major axis extending along a length of the fastening member and in the direction crossing the major axis of the one of the connection terminals.

19. The secondary battery module of claim 18, wherein the major axis of each of the fastening members is substantially perpendicular to the major axis of the one of the connection terminals.

20. A secondary battery module comprising:
a plurality of unit batteries, each comprising an electrode terminal;
a plurality of connection terminals threadedly coupled to and electrically connected to the electrode terminals of the unit batteries, each of the connection terminals comprising a contact surface;
a bus bar electrically connecting a first connection terminal of the connection terminals to a second connection terminal of the connection terminals, the first connection terminal being coupled to the electrode terminal of one of the unit batteries, and the second connection terminal being coupled to the electrode terminal of an adjacent one of the unit batteries; and
a plurality of fastening members coupling the first and second connection terminals to the bus bar, each of the fastening members comprising a bolt having a major axis extending in a direction that is substantially perpendicular or oblique to a major axis of a corresponding one of the first and second connection terminals,
wherein the bus bar comprises at least one contact surface contacting and parallel to the contact surface of each of the first and second connection terminals.
